(19) United States
(12) Patent Application Publication
(10) Pub. No.: US 2012/0118424 A1
(43) Pub. Date: May 17, 2012

(54) REINFORCEMENT AND METHOD FOR TUBULAR STRUCTURES

(75) Inventors: Marcel R. Cannon, Romeo, MI (US); Hesham A. Ezzat, Troy, MI (US); Jonathan E. Rich, Clinton Township, MI (US)

(73) Assignee: GM GLOBAL TECHNOLOGY OPERATIONS, INC., DETROIT, MI (US)

(21) Appl. No.: 12/948,571

(22) Filed: Nov. 17, 2010

(51) Int. Cl. F16L 9/00

(52) U.S. Cl. 138/172

(57) ABSTRACT

A reinforcement and method for reinforcing a hollow tubular structure includes a first sheet of flexible fiber material impregnated with resin. The first sheet is rolled into a tubular shape and a seam is provided between first and second lateral edges of the first sheet to form a tubular reinforcement. An inflatable bladder extends through the tubular reinforcement and is inflated to press the tubular reinforcement into contact with the inside wall of the tubular structure. Curing of the resin will bond the first sheet to the inside wall to reinforce the tubular structure. The first sheet can have a region of built-up thickness to provide additional reinforcement. The seam between the lateral edges of the first sheet can be a separable seam that separates when the bladder is inflated to allow the first sheet to contact with a region of the tubular structure that is of larger circumference than the circumference of the tubular reinforcement.

### FIELD OF THE INVENTION

The present invention relates to the reinforcement of a tubular structure and more particularly provides a fiber reinforced plastic reinforcement for reinforcing an inside wall of a tubular structure.

### BACKGROUND OF THE INVENTION

The prior art has proposed that hollow tubular structures, for example in vehicle body structures, can be reinforced by installing metal or plastic patches onto the inside or the outside of the tubular structure.

It would be desirable to provide a fiber reinforced plastic reinforcement on the inside of vehicle body structures, particularly if the reinforcing effect could be optimized to provide a lesser reinforcing effect in regions that need less reinforcement, and to provide a greater reinforcing effect in those regions that would benefit from increased reinforcement. Furthermore, it would be desirable to provide fiber reinforced plastic reinforcement within hollow tubular structures that have varying circumferential dimensions along the length thereof such as when a tubular structure has a bulge in the shape of the wall of the tubular structure.

### SUMMARY OF THE INVENTION

A reinforcement and method for reinforcing a hollow tubular structure includes providing a first sheet of flexible fiber material impregnated with resin and having first and second lateral edges extending between end walls. The first sheet is rolled into a tubular shape and a seam is provided between first and second lateral edges of the first sheet to form a tubular reinforcement. An inflatable bladder extends through the tubular reinforcement and is inflated to expand and press the tubular reinforcement into contact with the inside wall of the hollow tubular structure so that upon curing of the resin the first sheet will be bonded to the inside wall to reinforce the tubular structure. The first sheet can have a region of built-up thickness to provide additional reinforcement in a region of the tubular structure contacted by the region of built-up thickness. The region of built-up thickness can be provided by a second sheet of flexible fiber material that is attached to the first sheet. The seam between the lateral edges of the first sheet can be a separable seam that separates when the bladder is inflated to allow the first sheet to contact with a region of the tubular structure that is of larger circumference than the remainder of the tubular structure.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is a perspective view of flexible fiber sheets impregnated with resin.

FIG. 2 is a perspective view showing the flexible fiber sheets of FIG. 1 rolled to form a tubular reinforcement and an inflatable bladder for insertion into the tubular shape.

FIG. 3 is a perspective view of a metal tubular structure having the tubular reinforcement and the inflatable bladder inserted therein.

FIG. 4 is a section view similar to FIG. 3 but showing the inflatable bladder having been inflated to expand the tubular reinforcement into engagement with the inside walls of the tubular structure.

FIGS. 5 and 6 show alternative methods for creating a built-up region in a flexible sheet.

### DETAILED DESCRIPTION OF THE EXEMPLARY EMBODIMENTS

The following description of certain exemplary embodiments is merely exemplary in nature and is not intended to limit the invention, its application, or uses.

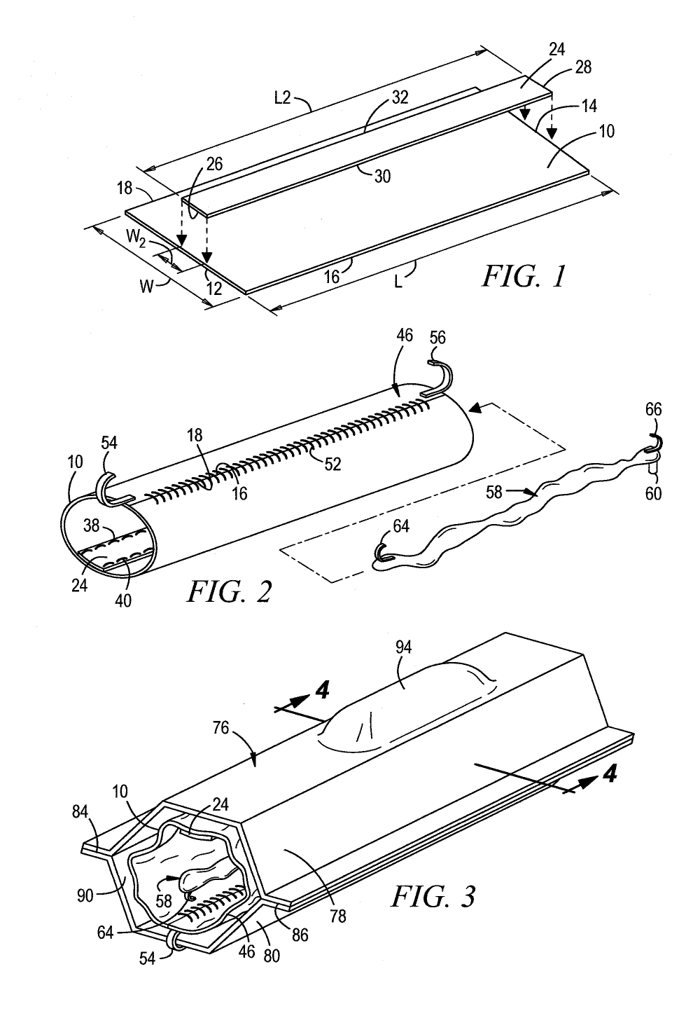

Referring to FIG. 1, a first sheet of 10 of flexible material is shown and includes a flexible fiber sheet that is impregnated with resin. The fiber sheet may be carbon fiber, fiberglass or other known fiber materials. The fibers of the fiber material can be unidirectional, woven, needle punched or of other manufacture. The sheet of fiber material is impregnated with a resin. This type of flexible sheet material is well known and commercially available, sometimes referred to as high-performance fiber reinforced plastic or fiber reinforced plastic.

As shown in FIG. 1, the first sheet 10 has ends 12 and 14 and lateral edges 16 and 18. The distance between the ends 12 and 14 defines the length L of the first sheet 10. The distance between the lateral edges 16 and 18 defines the width W of the first sheet 10.

FIG. 1 also shows a second sheet 24 of flexible material that overlies the first sheet 10. The second sheet 24 has ends 26 and 28 and lateral edges 30 and 32. The distance between the ends 26 and 28 defines the length L2 of the second sheet 24. The distance between the lateral edges 30 and 32 of the second sheet 24 define the width W2 of the second sheet 24.

FIG. 1 is a perspective view showing the second sheet 24 overlying the first sheet 10. FIG. 2 shows the second sheet 24 attached to the first sheet 10. The attachment of the second sheet 24 to the first sheet 10 is accomplished by any known means. For example, FIG. 2 shows a row of stitches 38 and a row of stitches 40. Alternatively, mechanical fasteners, such as staples, can be installed between the second sheet 24 in the first sheet 10. Or, an adhesive may be employed to attach the second sheet 24 to the first sheet 10. The resin impregnated into the first sheet 10 and second sheet 24 can act as the adhesive to adhere the second sheet 24 to the first sheet 10. The second sheet 24 serves to provide a built-up thickness of the first sheet 10.

FIG. 2 also shows that the first sheet 10 has been rolled into a tubular shape. The lateral edge 16 of the first sheet 10 has been suitably attached to the lateral edge 18 of the first sheet 10 so that the first sheet 10 has now become a flexible sock-like tubular reinforcement member, generally indicated at 46. The attachment between the lateral edges 16 and 18 is a row of stitches as shown at 52. Alternatively, the lateral edges 16 and 18 are attached by mechanical fasteners, such as staples, or by a suitable adhesive. FIG. 2 also shows wire hooks 54 and 56 suitably attached to the ends of the tubular reinforcement member 46. These hooks 54 and 56 will be used to position the tubular reinforcement member 46, as will be discussed further hereinafter.

FIG. 2 also shows an inflatable bladder 58 that is poised for insertion into the tubular reinforcement member 46. The inflatable bladder 58 is made of an expandable material, such as rubber or latex, and forms an airtight enclosure. Air or other fluid can be added to the inflatable bladder 58 through a check valve 60 in order to inflate or deflate the inflatable bladder 58. In addition, the inflatable bladder 58 has a first hook 64 at one end thereof and a second hook 66 at the other end thereof. These hooks 64 and 66 will be used to position the deflated bladder 58, as will be discussed further hereinafter.

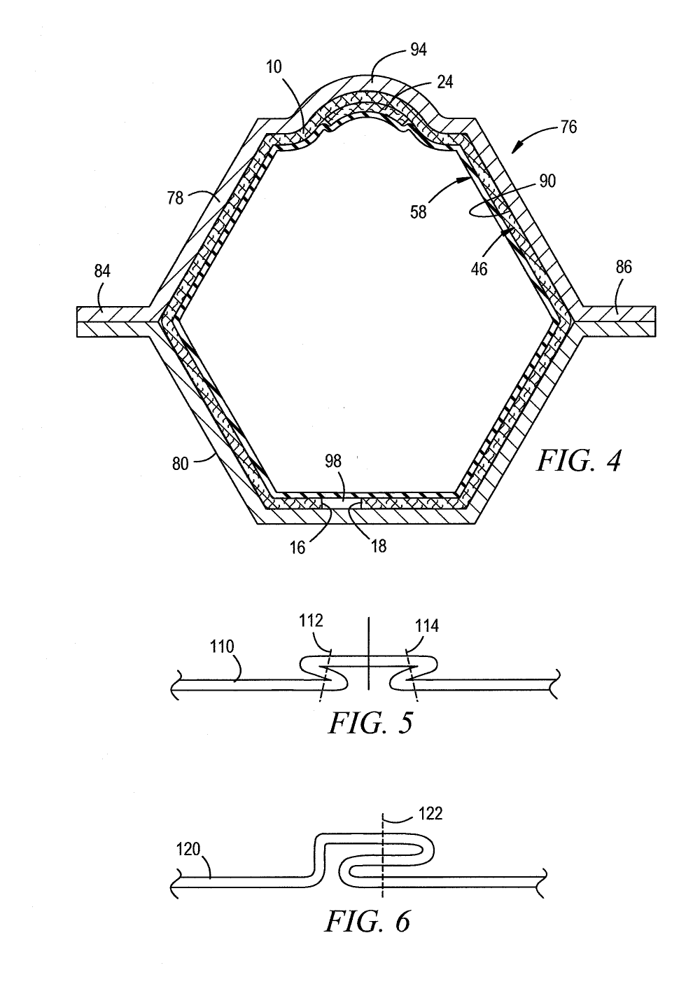

FIG. 3 is a perspective view showing a hollow tubular structure, indicated generally at 76. As shown in FIGS. 3 and 4 the hollow tubular structure 76 is, for example, hexagonal in cross section and is made of an upper tube half 78 and a lower tube half 80 that are welded together at flanges 84 and 86. The hollow tubular structure 76 has an inside wall 90 that defines the circumference or perimeter of the hollow tubular structure 76. As seen in FIGS. 3 and 4, the hollow tubular structure 76 has a bulge 94 in one of its walls. The circumference defined by the inside wall 90 is a lesser circumference at those regions of the hollow tubular structure 76 without the bulge 94, and is a greater circumference in those regions where the bulge 94 occurs.

In FIG. 3, it is seen that the tubular reinforcement member 46 has been inserted into the hollow tubular structure 76 and is retained in place by fitting the hooks 54 and 56 over the ends of the hollow tubular structure 76. As seen in FIG. 3, the tubular reinforcement member 46 has been oriented so that the built-up region provided by the second sheet 24 is aligned with the wall of the hollow tubular structure 76 that has the bulge 94. FIG. 3 also shows that the deflated bladder 58 has been inserted into the tubular reinforcement member 46 and its hooks 64 and 66 have been hooked over the ends of the hollow tubular structure 76.

In FIG. 4, it will be seen that the inflatable bladder 58 has been inflated so that the tubular reinforcement member 46 has been expanded and pushed outwardly to have full contact with the inside wall 90 of the hollow tubular structure 76, including that part of the inside wall 90 within the bulge 94. As discussed above, the circumference of the inside wall 90 is greatest at the region containing the bulge 94. Accordingly, as seen in FIG. 4, the outward expansion of the tubular reinforcement member 46 into the bulge 94 has caused the row of stitches 52 acting between the lateral edges 16 and 18 of the first sheet 10 to be broken or pulled apart, thus creating a gap 98 in the tubular reinforcement member 46. In this way, the pulling apart of the stitches 52 has enabled the tubular reinforcement member 46 to expand outwardly into the bulge 94 to provide assured reinforcement of that region of the hollow tubular structure 76 that contains the bulge 94. In addition, that portion of the first sheet 10 having the built-up thickness provided by the second sheet 24 attached thereto has been positioned into contact with the inside wall 90 at the bulge 94 so that the presence of the second sheet 24 is providing an additional built-up thickness and reinforcing effect at the region of the bulge 94.

After the tubular reinforcement member 46 has been engaged with the inside wall 90 as shown in FIG. 4, the resin that is impregnated into the first sheet 10 and the second sheet 24 will be cured. This curing can occur, for example, by applying heat to the hollow tubular structure 76. The inflatable bladder 58 can be kept inflated and in place to firmly hold the tubular reinforcement member 46 against the inside wall 90 during the curing. Alternatively, the resin that is impregnated into the first sheet 10 may be sufficiently tacky to hold the tubular reinforcement member 46 in contact with the inside walls 90 without the assistance of the bladder 58, so that the bladder can be deflated and removed prior to the curing of the resin. On the other hand, is also possible to leave the inflatable bladder 58 in place within the hollow tubular structure 46 either temporarily or permanently, particularly if removal of the bladder 58 is difficult or awkward due to the shape of the hollow tubular structure 76 or its incorporation into a larger vehicle body structure.

Although FIGS. 1 through 4 show a first embodiment of the invention, it will be understood that a person of ordinary skill will appreciate that many alternative embodiments are within the scope of the invention. For example, FIG. 1 shows the built-up thickness of sheet 10 being provided by a second sheet 24 that is the same length as the first sheet 10. However, the size of the second sheet 24 can be tailored as appropriate to provide the desired built-up thickness and additional reinforcement at any greater or lesser region of the first sheet 10. For example, if desired, the second sheet 24 can be sized and located on the first sheet 10 in any position that will provide additional reinforcement at only the bulge 94.

FIG. 5 shows an alternative arrangement in which the built-up thickness of a first sheet 110 can be provided by creating a fold in the first sheet 110 and then providing stitches at 112 and 114. Similarly, FIG. 6 shows yet another alternative arrangement in which a first sheet 120 has been gathered and folded downwardly and a row of stitches 122 is provided to provide a region of built-up thickness. Thus the region of built-up thickness can be provided by folding the first sheet onto itself, creating an overlap to provide the built-up thickness

FIG. 2 shows metal hooks that have been sown to the ends of the inflatable bladder 58 and at the ends of the tubular reinforcement member 46. In some cases, the tubular reinforcement member 46 may have sufficient rigidity that the use of hooks 54 and 56 can be eliminated. In addition it will be understood that the hooks 54 56, 64, and 66 are just one example of a mechanism that can be used to reliably position the tubular reinforcement member 46 and the inflatable bladder 58 within the hollow tubular structure 76. For example, adhesives, snap fasteners, rivets, or other known fasteners can be employed to accomplish either a temporary or permanent positioning of the tubular reinforcement member 46 and/or inflatable bladder 58 within the tubular structure 76.

The seam that attaches together the lateral edges 16 and 18 of the first sheet 10 can be either separable or permanent. In some cases, it may be desirable to provide permanent stitching or other permanent attachment along a part of the length of the lateral edges 16 and 18, while providing a separable pull-apart attachment along another part of the length of the lateral edges 16 and 18.

FIGS. 3 and 4 of the drawings herein show the region of built-up thickness provided by the second sheet 24 as being aligned with and contacting the bulge 94. However, another region of the structural member 76 that can benefit from the additional reinforcing effect of the second sheet 24 would be the location of the welded joint between the upper tube half 78 and the lower tube half 80. If desired, the tubular reinforcement member 46 can be oriented within the structural member 76 with the second sheet 24 aligned to overlap the joint between the upper tube half 78 and lower tube half 80. Also, it may be desirable to provide a plurality of second sheets 24 at various locations upon the tubular reinforcement member 46 so that the structural member 76 can be reinforced at multiple locations. In addition, although FIG. 3 shows the example of the structural member with upper and lower halves 78 and 80, it is also very common in motor vehicle structures to join tubular sections end to end, with either a butt joint or a lap joint. The present invention may be advantageously employed to provide reinforcement at the lap joint or butt joint where tubular structures are connected together end to end.

Thus, it is seen that the invention provides a new and improved reinforcement and reinforcement method for reinforcing hollow tubular structures.

What is claimed is:

1. A reinforcement for reinforcing a hollow tubular structure having an inside wall comprising:
a first sheet of flexible fiber material impregnated with resin and having first and second lateral edges extending between end walls;
the first sheet having a region thereof of built-up thickness;
the first sheet being rolled into a tubular shape and having a seam provided between the first and second lateral edges so that the first sheet is formed into a tubular shape;
and an inflatable bladder extending through the tubular shape of the first sheet for inflation to expand the first sheet into contact with the inside wall of the hollow tubular structure so that upon curing of the resin the first sheet and the region of built-up thickness will be bonded to the inside wall to reinforce the tubular structure.

2. The reinforcement of claim 1 further comprising the region of built-up thickness being a second sheet of flexible fiber material impregnated with resin and attached to the first sheet.

3. The reinforcement of claim 1 further comprising the region of built-up thickness being provided by creating a fold in the first sheet so that a portion of the first sheet overlies itself and creates the built-up thickness.

4. The reinforcement of claim 1 further comprising the seam attaching the first and second lateral edges of the sheet being a separable seam that separates if and where needed in order to allow the bladder to press the first sheet against the inside wall of the tubular structure.

5. The reinforcement of claim 1 further comprising the seam attaching the first and second lateral edges of the sheet being a permanent seam that continues to attach the first and second lateral edges of the sheet when the inflated bladder presses the first sheet against the inside wall of the tubular structure.

6. The reinforcement of claim 2 further comprising the region of built-up thickness being attached to the first sheet by stitches, an adhesive, or mechanical fasteners.

7. The reinforcement of claim 1 further comprising the seam between the first and second lateral edges of the first sheet being stitches, an adhesive, or mechanical fasteners.

8. A reinforcement for reinforcing a hollow tubular structure having an inside wall comprising:
a first sheet of flexible fiber material impregnated with resin and having first and second lateral edges extending between end walls;
the first sheet being rolled into a tubular shape and having a seam provided between the first and second lateral edges so that the first sheet is formed into a tubular shape;
a bladder extending through the tubular shape of the first sheet for inflation to expand the second sheet into contact with the inside wall of the hollow tubular structure so that upon curing of the resin impregnated in the fiber of the first sheet and the region of built-up thickness will be bonded to the inside wall to reinforce the tubular structure;
said seam attaching the first and second lateral edges of the sheet being a separable seam that separates if and where needed in order to allow the bladder to press the first sheet against the inside wall of the tubular structure.

9. The reinforcement of claim 8 further comprising said first sheet having a region thereof of built-up thickness.

10. The reinforcement of claim 9 further comprising the region of built-up thickness being provided by a second sheet of flexible fiber material impregnated with resin and attached to the first sheet.

11. The reinforcement of claim 10 further comprising the region of built-up thickness being attached to the first sheet by stitches, an adhesive, or mechanical fasteners.

12. The reinforcement of claim 9 further comprising the region of built-up thickness being provided by creating a fold in the first sheet so that a portion of the first sheet overlies itself and creates the built-up thickness.

13. The reinforcement of claim 10 further comprising the separable seam between the first and second lateral edges of the first sheet being provided by one or more rows of stitches, by an adhesive or by a plurality of mechanical fasteners.

14. A method of reinforcing a hollow tubular member having an inside wall comprising the steps of:
providing a first sheet of flexible material impregnated with resin, said sheet having first and second lateral edges extending between the ends thereof and having at least one region of built-up thickness thereon;
rolling the first sheet into a tubular shape and attaching together the first and second lateral edges thereby creating a tubular reinforcement member of flexible material impregnated with resin and having at least one region of built-up thickness on the tubular member;
inserting the tubular reinforcement member of flexible material into the tubular structural member;
inserting an inflatable bladder into the tubular reinforcement member of flexible material and inflating the bladder so that the tubular reinforcement member of flexible material is expanded outwardly into contact with the inside wall of the tubular structural member;
and curing the resin so that the tubular reinforcement member is permanently adhered to the inside wall of the tubular structural member with the region of built-up thickness providing additional reinforcement of a part of the tubular structural member in the region of contact between the built-up thickness and the inside wall of the tubular structural member.

15. The method of claim 12 further comprising the first and second lateral edges of the first sheet being attached together by a separable seam so that if the circumference of the structural tubular member exceeds the circumference of the tubular member the separable seam will separate and allow the first sheet to be expanded outwardly into full contact with the inside wall of the tubular structural member under the urging of the inflatable bladder.

16. The method of claim 12 further comprising the inflatable bladder being adhered to the tubular member of flexible material so that the inflatable bladder continues to reside within the reinforced structural member after the curing of the resin.

17. The method of claim 12 further comprising the inflatable bladder being removed from the tubular reinforcement member after the inflation of the inflatable bladder has caused the first sheet of flexible material to be expanded outwardly into contact with the inside walls of the tubular structural member.

18. A method of reinforcing a hollow tubular member having an inside wall comprising the steps of:
providing a first sheet of flexible material impregnated with resin, said sheet having first and second lateral edges extending between the ends thereof and having at least one region of built-up thickness thereon;
rolling the first sheet into a tubular shape and attaching together the first and second lateral edges via a separable seam thereby creating a tubular reinforcement member of flexible material impregnated with resin;
inserting the tubular reinforcement member of flexible material into the tubular structural member;
inserting an inflatable bladder into the tubular reinforcement member of flexible material and inflating the bladder so that the tubular reinforcement member of flexible material is expanded outwardly into contact with the inside wall of the tubular structural member and to separate the separable seam where necessary to permit the outward expansion;
and curing the resin so that the tubular reinforcement member is permanently adhered to the inside wall of the tubular structural member.

19. The method of claim 18 further comprising providing a region of built-up thickness on the first sheet to provide additional reinforcement of a part of the tubular structural member in the region of contact between the built-up thickness and the inside wall of the tubular structural member.

20. The method of claim 18 further comprising the inflatable bladder being adhered to the tubular member of flexible material so that the inflatable bladder continues to reside within the reinforced structural member after the curing of the resin.
